(19) United States
(12) Patent Application Publication
(10) Pub. No.: US 2010/0270424 A1
(43) Pub. Date: Oct. 28, 2010

(54) HYBRID AIRSHIP

(76) Inventor: James D. DeLaurier, Concord (CA)

Correspondence Address: SIM & MCBURNEY, 330 UNIVERSITY AVENUE, 6TH FLOOR, TORONTO, ON, M5G 1R7, CA

(21) Appl. No.: 12/429,542

(22) Filed: Apr. 24, 2009

(51) Int. Cl. B64B 1/20; G09F 21/08; B64B 1/12

(52) U.S. Cl. 244/25; 40/212; 244/96

(57) ABSTRACT

A hybrid airship comprises a non-rigid body having a delta-wing shape and an airfoil cross-section. The body is shaped for generating aerodynamic lift during forward flight, and contains a gas for generating buoyancy lift. At least one splitter plate is pivotally connected along a trailing edge of the body. The splitter plate is configured to be controllably pivoted for controlling the airship.

### FIELD OF THE INVENTION

The present invention relates generally to aircraft and particularly to a hybrid airship.

### BACKGROUND OF THE INVENTION

Hybrid airships are generally defined as airships that combine the characteristics of heavier-than-air aircraft (e.g. “fixed-wing” aircraft, such as airplanes) and conventional airships (e.g. blimps). Hybrid airships generate lift through both airfoil-based aerodynamics and internal buoyancy, and consequently they possess a number of the advantageous features of both fixed-wing aircraft and conventional airships. For example, hybrid airships can provide the extended operational range and the greater endurance and fuel efficiency of conventional airships, with the maneuverability and higher speeds of fixed-wing aircraft.

Hybrid airships have been designed in both rigid and non-rigid forms. A non-rigid hybrid airship typically comprises an inflatable body formed of a flexible material and has an airfoil-shaped cross-section. The non-rigid hybrid airship is buoyed by a lighter-than-air gas such as helium that is contained within the body. In contrast, rigid hybrid airships comprise a (non-inflatable) rigid body that is made of a comparatively stiff material, such as aluminum, and having an airfoil-shaped cross-section and containing a lighter-than-air gas for buoyancy. Non-rigid hybrid airships are typically simpler and more economical in design and construction than their rigid counterparts, and often require a lower cost of maintenance.

Several non-rigid hybrid airships have been disclosed. For example, U.S. Pat. No. 6,196,498 to Eichstedt et al. discloses a non-rigid, semi-buoyant airship that includes a pressure stabilized gasbag having front and rear ends and an aerodynamic shape capable of producing lift. A horizontal tail surface is mounted outboard of the rear end of the gasbag, having a trailing edge extending outward along a horizontal axis from each side of a longitudinal axis of the gasbag. The gasbag further includes a plurality of vertical catenary curtains attached between the top and bottom surfaces of the gasbag.

U.S. Pat. No. 7,093,789 to Barocela et al. discloses a hybrid airship including a plurality of helium filled gas envelopes, and an all-electric propulsion system having the shape of a delta-wing. In some embodiments, the airship may be launched using buoyancy lift alone and aerodynamic lift may be provided by the all-electric propulsion system. A photovoltaic array and a high energy density power storage system may be combined to power the propulsion system. A non-rigid hybrid airship embodiment is disclosed.

A non-rigid airship comprises an inflatable body made of a flexible material and which, by virtue of this construction, has rounded edges. While rounded edges are desired for most surfaces of the airfoil-shaped body, such as the leading edge, rounded edges on the trailing edge of the airfoil present an edge that is aerodynamically “blunt”, and can give rise to a region of turbulent flow separation behind this trailing edge. Flow separation contributes to the overall aerodynamic drag of the airship, specifically the “base drag”, and also prevents traditional control surfaces, such as ailerons or elevators, from operating effectively within this separated flow region.

More specifically, traditional control surfaces rely primarily on a sharp trailing edge to which the flow may remain attached, so as to maintain the Kutta condition at the trailing edge (in the field of aerodynamics, the Kutta condition refers to the flow pattern that arises when fluid flowing around a body having a sharp edge approaches this edge from both directions, meets at the edge, and then flows away from the body; none of the fluid flows around the edge or remains otherwise attached to the body). The control surface of a conventional airfoil, when deflected, produces a change in the pressure distribution along the entire upper and lower surfaces of the wing. In contrast, a rounded trailing edge gives rise to significant flow separation, for which the Kutta condition cannot be maintained.

The installation of a traditional control surface on a rounded trailing edge could potentially result in flow around the trailing edge rather than flow leaving tangentially from the airfoil surface. Additionally, the attachment of a traditional conventional control surface to a rounded trailing edge would require cutting into and providing a hinged panel within the rounded edge. Such a modification of a rounded trailing edge would increase both the complexity and the cost of the airship.

### SUMMARY OF THE INVENTION

Accordingly, in one aspect there is provided a hybrid airship comprising:
a non-rigid body having a delta-wing shape and an airfoil cross-section, the body shaped for generating aerodynamic lift during forward flight, and containing a gas for generating buoyancy lift; and
at least one splitter plate pivotally connected along a trailing edge of the body, the splitter plate configured to be controllably pivoted for controlling the airship.

According to an embodiment, the airship further comprises a control system for controllably pivoting the splitter plate. In one form, the control system comprises an actuator. In another form, the actuator is an electric motor.

According to another embodiment, the splitter plate is connected to an inner shaft, the inner shaft being rotatably housed in an outer shaft mounted to the body. In one form, the outer shaft is mounted to the body by load patches.

In another aspect, there is provided splitter plate for a hybrid airship configured to be pivotally connected along a trailing edge of a body of the hybrid airship, the splitter plate configured to be controllably pivoted for controlling the airship.

### BRIEF DESCRIPTION OF THE DRAWINGS

Embodiments will now be described more fully with reference to the accompanying drawings in which:

FIG. 1 is a perspective view of a hybrid airship, according to an embodiment of the present invention;

FIG. 2 is a side elevation view of the airship of FIG. 1;

FIG. 3 is a front elevation view of the airship of FIG. 1;

FIG. 4 is a top plan view of the airship of FIG. 1;

FIG. 5 is a rear elevation view of the airship of FIG. 1;

FIG. 6 is a partial cross-sectional top view of the airship of FIG. 1;

FIG. 7 is a cross-sectional front elevation view of the airship of FIG. 1;

FIG. 8 is a cross-sectional side elevation view of the airship of FIG. 1;

FIG. 9 is an enlarged perspective view of a splitter plate of the airship of FIG. 1;

FIG. 10 is a magnified perspective view of a portion of the splitter plate of FIG. 9;

FIG. 11 is a magnified perspective view of another portion of the splitter plate of FIG. 9;

FIGS. 12a to 12e are top plan, front elevation, upper perspective, side elevation, and lower perspective views, respectively, of an alternative hybrid airship having a gondola;

FIGS. 13a to 13e are top plan, front elevation, upper perspective, side elevation, and lower perspective views, respectively, of another alternative hybrid airship having a gondola; and

FIGS. 14a to 14e are top plan, front elevation, upper perspective, side elevation, and lower perspective views, respectively, of still another alternative hybrid airship having display panels.

### DETAILED DESCRIPTION OF THE EMBODIMENTS

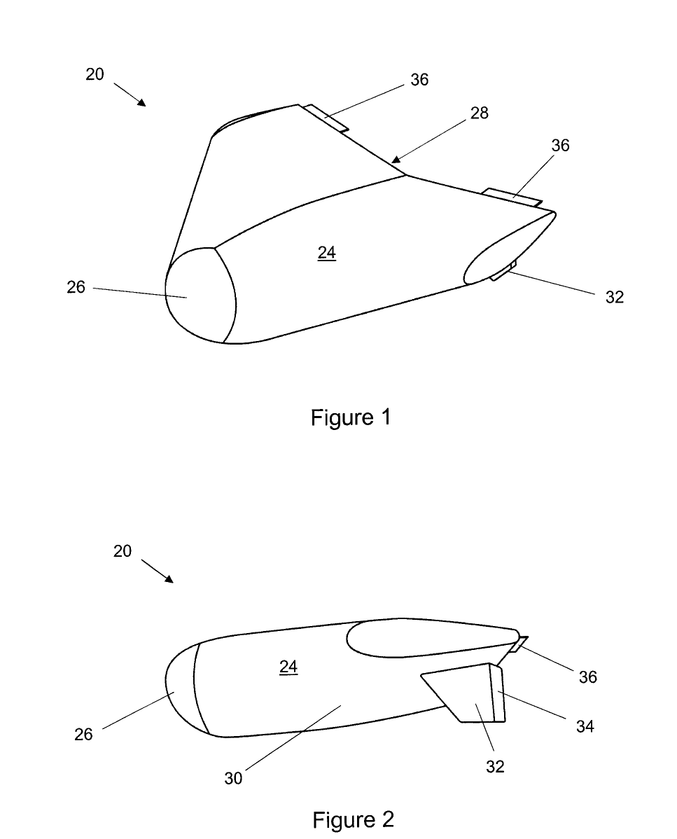

Turning now to the figures, FIGS. 1 to 5 show various views of a non-rigid hybrid airship, which is generally indicated by reference numeral 20. Airship 20 has a delta-wing shape, as can be seen particularly in FIG. 4. Airship 20 also has an airfoil-shaped cross-sectional profile, as best seen in FIG. 2. As would be understood, the airfoil-shaped profile enables hybrid airship 20 to generate aerodynamic lift during forward flight. Hybrid airship 20 also comprises an internal volume of gas having density lower than air, such as helium, contained within for generating buoyant lift.

By “delta-wing” shape, it is meant that body 24 has a generally triangular shape, as viewed from above. By “airfoil” cross-section, it is meant that body 24 has a cross-sectional shape that is capable of generating aerodynamic lift, and which is therefore similar in shape and function to a wing of a standard airplane.

Airship 20 comprises a non-rigid, inflatable body 24 that is made of a flexible sheet material. Body 24 comprises a nose 26 at the apex of its leading edges having a generally semi-hemispherical shape, and body 24 also comprises a trailing edge 28.

FIG. 2 shows a side elevation view of airship 20 in which underside 30 is visible. Underside 30 comprises two fins 32 extending therefrom and positioned towards the aft of body 24 near trailing edge 28. Each fin 32 has a rudder 34, and each rudder 34 is controllably pivotable around a longitudinal axis. The two rudders 34 together provide substantially vertical control surfaces for airship 20.

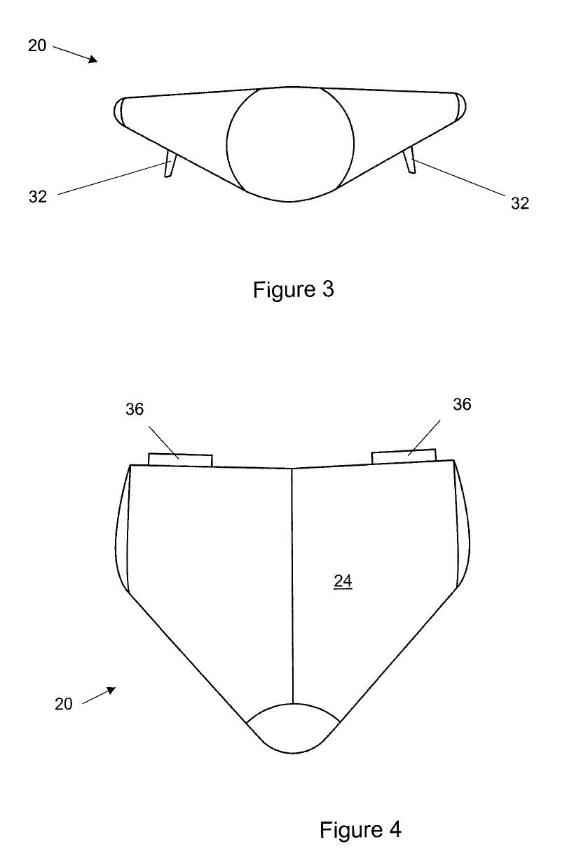

FIG. 3 is a front elevation view of airship 20, in which it can be seen that each fin 32 extends generally downwardly from underside 30 of airship 20.

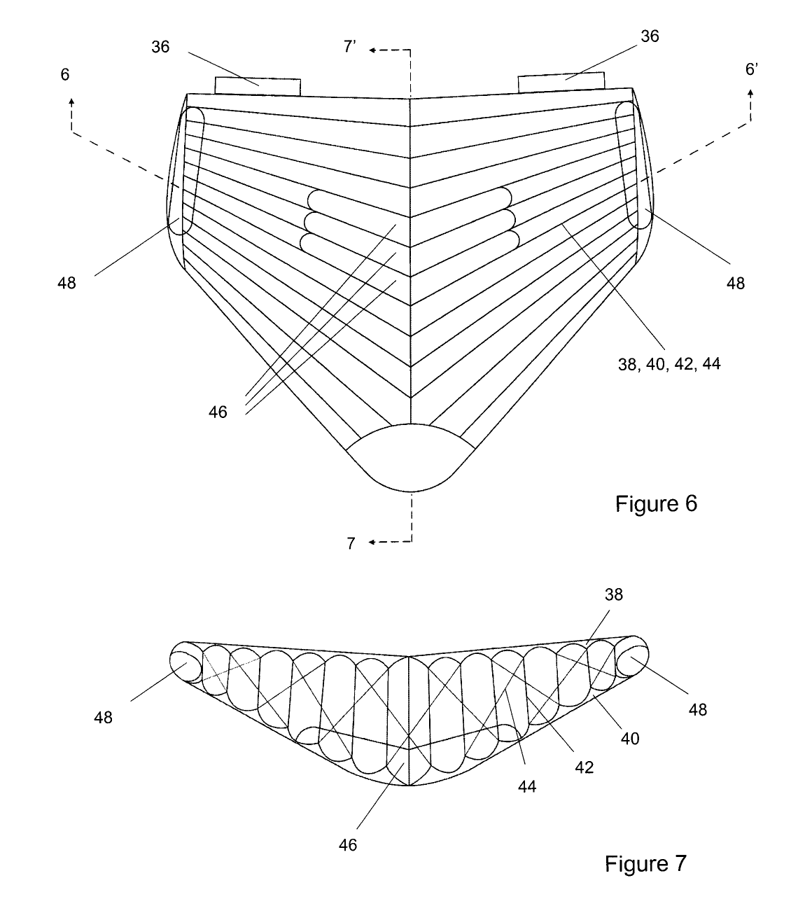

The internal structure of body 24 of airship 20 is shown in FIGS. 6 to 8. The shape of body 24 is maintained against internal pressure by an assemblage of webbings 38 and 40 and cables 42 and 44. Upper webbing 38 and lower webbing 40 are connected to respective upper and lower interior surfaces of body 24. Upper webbing 38 and lower webbing 40 are connected to each other by vertical cables 42, and by diagonal cables 44, as shown. The assemblage of webbings 38 and 40, and cables 42 and 44 provides internal strength to body 24 and serves to prevent significant distortions of shape of body 24, allowing body 24 to maintain its delta-wing and cross-sectional airfoil shapes during operation.

The interior of body 24 also comprises center ballonets 46 and wingtip ballonets 48. Ballonets 46 and 48 are air-filled bags within the interior of body 24. Ballonets 46 and 48 have flexible walls and are vented to the exterior of airship 20 through respective valves 47 and 49 (not shown). Ballonets 46 and 48 and valves 47 and 49 enable the volume of lighter-than-air gas contained within body 24 to expand and to contract when airship 20 gains or loses altitude, respectively, during which the flexible ballonets compensate by deflating and inflating, respectively, as needed. This induced deflation and inflation of ballonets 46 and 48 causes them to expel and intake air, respectively, from the exterior of airship 20. Additionally, each of the valves 47, and each of the two valves 49, can be controlled independently, enabling the airflow into and out of each of the center ballonets 46 and into and out of each of the wingtip ballonets 48 to be regulated. This feature is particularly useful for controlling the roll of airship 20 when it is moving at low relative air speeds, at which time the flight control surfaces are less effective.

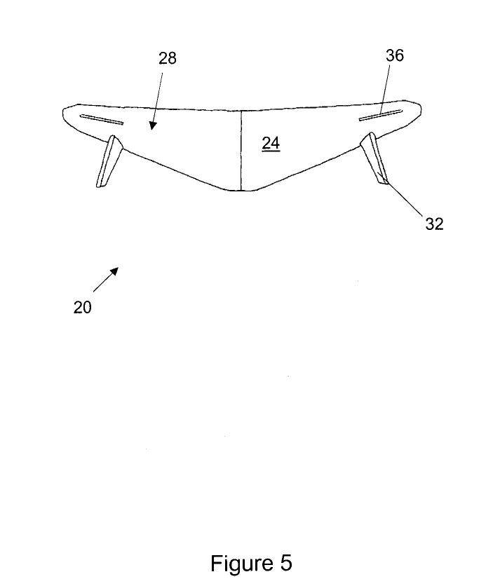

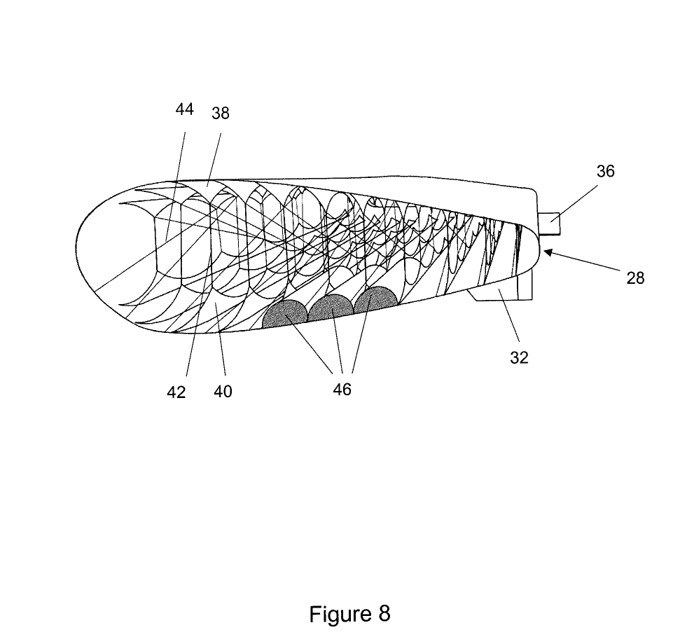

Turning now to the splitter plate system, FIGS. 4 and 5 show two splitter plates 36 mounted along trailing edge 28 of body 24. In the embodiment shown, splitter plates 36 are mounted on opposite sides of the centerline of body 24. Each splitter plate 36 serves to provide control of both the pitch and the roll of airship 20. Further details about the structure and function of splitter plates 36 are discussed with reference to FIGS. 8 to 11 below.

Each splitter plate 36 alters the aerodynamically-generated pressure distribution on body 24, causing airship 20 to rotate, which in turn results in a change in the attitude of airship 20. As body 24 is an inflatable, non-rigid structure, trailing edge 28 of body 24 is rounded, as shown in FIG. 8, and therefore presents an edge that is aerodynamically blunt as compared to the trailing edges of conventional airfoils, such as an airplane wing. This is a notable structural difference between the “airfoil” cross-section of body 24, and the cross-section of a standard airplane wing (it should also be noted that despite this difference, body 24 is still capable of generating lift as a result of its “airfoil” cross-sectional shape). Owing to this roundness at trailing edge 28, the airflow around body 24 separates at trailing edge 28 and generates a volume of turbulent flow separation in its wake. Conventional flight control surfaces, such as elevators or ailerons used on heavier-than-air aircraft, do not function properly in this region of separated flow. This is due to the fact that conventional controls rely on the flow being attached to their surfaces in order to affect the change in pressure distribution over the entire lifting surface (including the control surface). If flow separates on the lifting surface, such that the control surface is in separated flow, it can no longer function effectively (note that this differs from the principle of a splitter plate aft of a blunt trailing edge, which acts to modify the base pressure). Additionally, such conventional control surfaces would be difficult to attach to the trailing edge 28 of non-rigid body 24. This is due to the fact that Traditional aircraft control surfaces typically take the form of panels of the wing that are cut out and hinged. In the present case, body 24 is inflatable and cutting a section is infeasible. Moreover, if it were attempted, the blunt trailing edge 28 would result in ineffective control surfaces due to flow separation.

Splitter plates 36 each have flat, planar shape and, despite the flow separation occurring with the wake of trailing edge 28, each splitter plate 36 can effectively alter the aerodynamically-generated pressure distribution within this region and acting on body 24 when pivoted about an axis parallel to trailing edge 28. More specifically, the presence of splitter plate 36 modifies the separated wake aft of the trailing edge such that, when deflected, a pressure difference is created both between opposite sides of the surface of splitter plate 36, and aft of trailing edge 28. The pressure difference alters the aerodynamic pressure distribution on body 24, so as to cause a rotation of airship 20. The magnitude of this pressure difference is proportionally related to the angle between splitter plate 36 and body 24, as verified by preliminary research and experimentation. Thus, as the angle of each splitter plate 36 relative to body 24 can be varied, similarly to an elevator or to an aileron used with a conventional airfoil, splitter plates 36 provide moveable flight control surfaces for airship 20. In the embodiment shown, the flight control surfaces of airship 20 comprise splitter plates 36 and rudders 34.

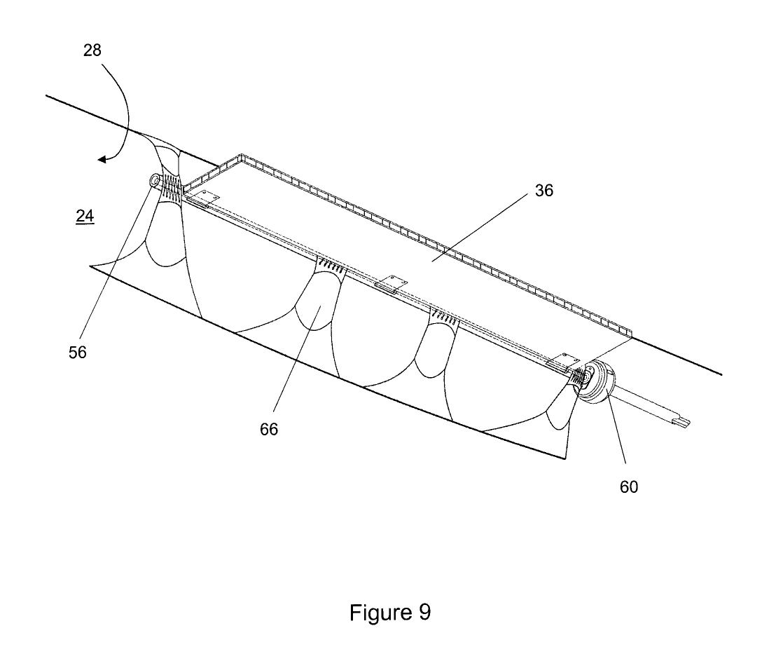

FIGS. 9 to 11 show magnified views of splitter plate 36 in greater detail. Splitter plate 36 is mounted on body 24 at trailing edge 28. Each splitter plate 36 is affixed to an inner shaft 54, which has a longitudinal axis defining the pivot axis of splitter plate 36. Splitter plate 36 is pivoted around this pivot axis by an actuator 60, which is connected to a first end of inner shaft 54 and is mounted on outer shaft 56. Actuator 60 is an electric motor.

Splitter plate 36 has a flat structure and, in the embodiment shown, has a lightweight composite construction having a honeycomb core comprised of any lightweight stiff material, including polymer-based composites and low density metals and metal alloys. In the embodiment shown, splitter plate 36 has a length and width of approximately ⅙ d and 1/24 d, respectively, where d is shortest distance from the trailing edge 28 to the imaginary point at which the two leading-edges of body 24 would intersect, if the rounded nose 26 were not present. The thickness of splitter plate 36 is approximately 1/10 the value of the width, or approximately 1/240 d.

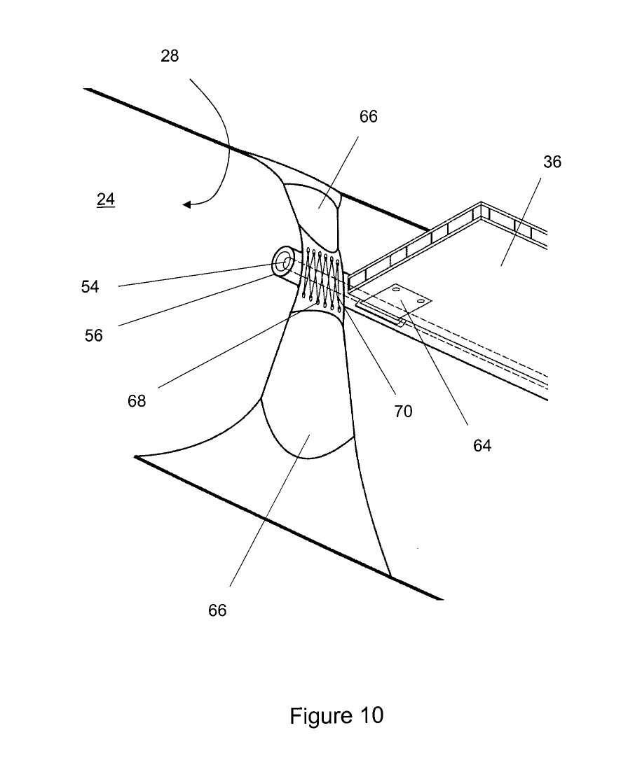

FIG. 10 shows a free end of inner shaft 54. Splitter plate 36 is connected to inner shaft 54 by bracket 64. Inner shaft 54 is housed co-axially within outer shaft 56, in which inner shaft 54 is free to rotate and thereby defines the pivot axis of splitter plate 36. Outer shaft 56 is fastened to body 24 by load patches 66. Each load patch 66 is itself attached to an outer surface of body 24, and has a single free edge having a plurality of grommets 68. Grommets 68 of adjacent load patches 66 are secured together with lacing 70, thereby enabling outer shaft 56 to be fastened to body 24, and in turn to be mounted to body 24.

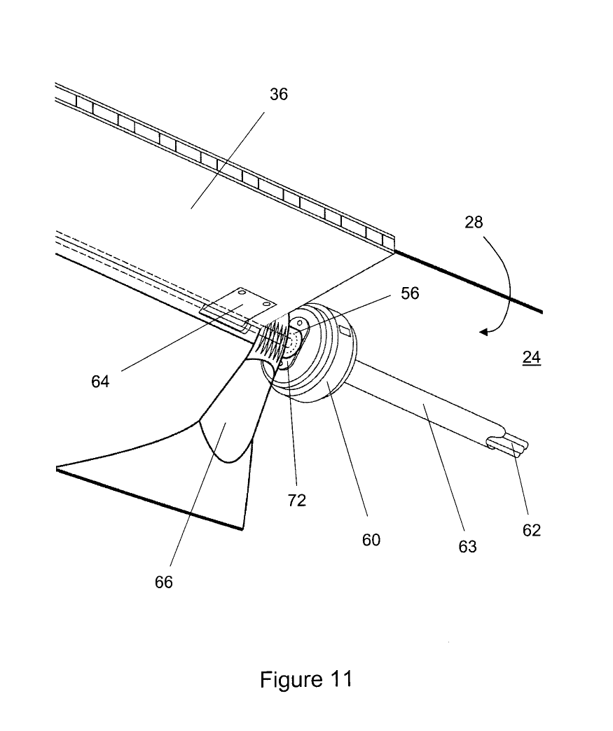

FIG. 11 shows the connection of the actuator to the splitter plate. Actuator 60 is mounted on mounting plate 72, which is itself connected to outer shaft 56. It may be appreciated that this configuration enables inner shaft 54 to be rotatably driven around its pivot axis within outer shaft 56 by actuator 60. In the embodiment shown, actuator 60 is an electric motor, which can be operated in either a forward or a reverse direction, and which in turn allows splitter plate 36 to be raised or lowered with respect to body 24. In this manner, splitter plate 36 functions as a moveable control surface for airship 20. Splitter plate 36 may also be described as having a neutral position, in which splitter plate 36 is oriented essentially coplanar with the chord of body 24. Movement of splitter plate 36 by actuator 60 is enabled by an electrical signal supplied to actuator 60 through cables 62, which are housed in an electrical cable sheath 63, and which are connected to a gondola 80 of airship 20.

As mentioned above, the pivoting of splitter plate 36 up or down around its pivot axis alters the aerodynamically-generated pressure distribution on body 24, so as to cause a rotation of airship 20 while in forward flight (i.e. when air is moving over body 24 from the leading-edge to the trailing-edge 28). When both splitter plates 36 are pivoted in the same direction, splitter plates 36 function to control the pitch of airship 20, defined as a rotation of airship 20 about its lateral axis. When each of the two splitter plates 36 is pivoted in an opposite direction from the other, splitter plates 36 function to control the roll of airship 20, defined as a rotation of airship 20 about its longitudinal axis. Here, the longitudinal axis of airship 20 is defined as an imaginary line collinear with the chord of body 24, and the lateral axis of airship 20 is defined as an imaginary line perpendicular to the longitudinal axis of airship 20 and passing through the center of mass of its vertical plane of symmetry.

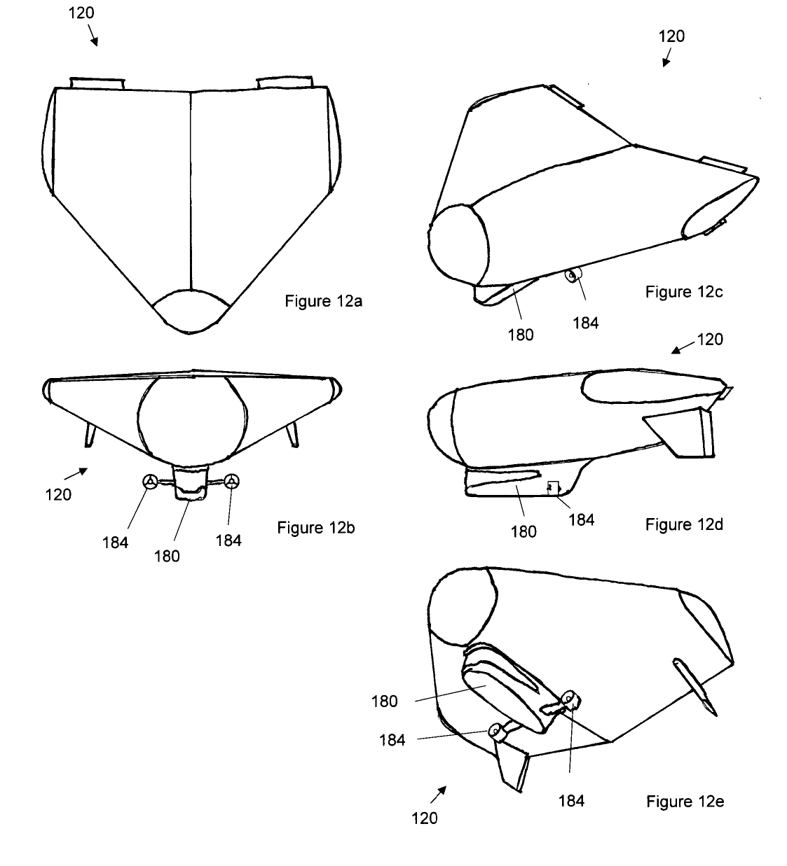

FIGS. 12 to 14 show the hybrid airship of the present invention in a variety of embodiments. FIGS. 12a to 12e show a variety of views of an embodiment of an airship 120 equipped with both a gondola and a propulsion system. Gondola 180 is positioned underneath the body of airship 120, and specifically, on the underside of airship 120. Gondola 180 comprises a system for piloting airship 120 and, in the embodiment shown, gondola 180 comprises cockpit controls that are operated by a manned flight crew. Airship 120 also comprises a propulsion system and, in the embodiment shown, the propulsion system comprises two engines 184 which are each affixed to the port and starboard side of gondola 180. Each engine 184 provides thrust to propel airship 120 in a forward direction. Each engine 184 may also provide reverse thrust for airship 120 as needed, for example, to provide braking or to facilitate maneuvering during landing.

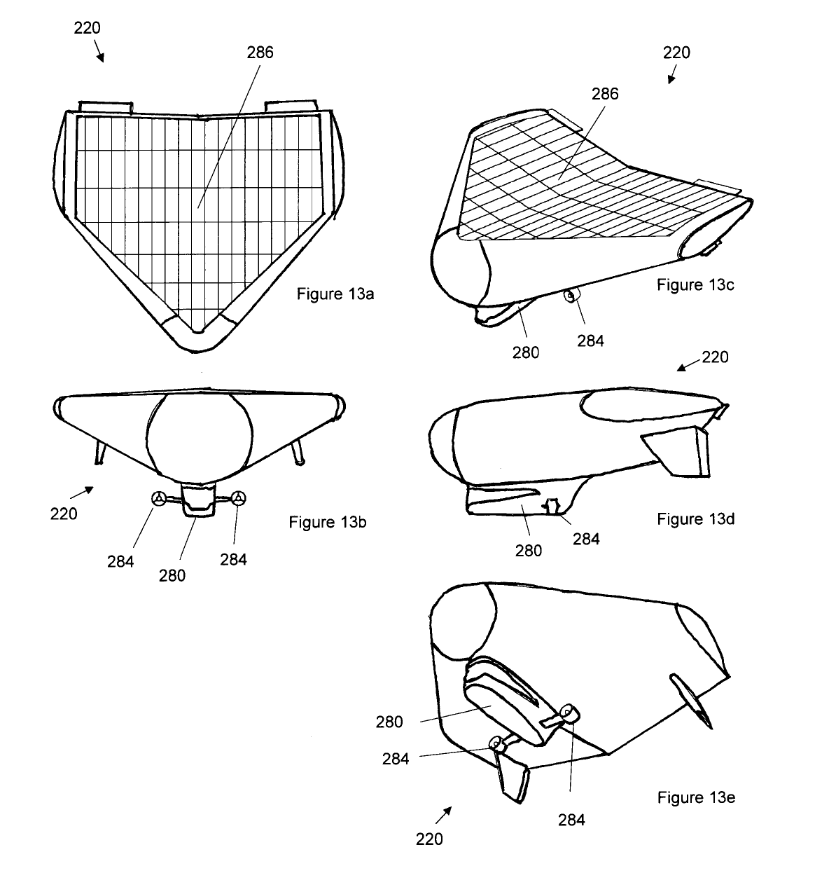

FIGS. 13a to 13e shows a variety of views of an embodiment of an airship 220 of the present invention, equipped with a gondola 280, a propulsion system comprising two engines 284, and a photovoltaic panel 286. Photovoltaic panel 286 is positioned on the upper surface of the body of airship 220, and enables airship 220 to generate photovoltaic power, and specifically photovoltaic electricity. Solar panel 286 is also connected to a power storage system 288 (not shown) and, in the present embodiment, storage system 288 is a battery array contained within gondola 280. Power storage system 288 stores photovoltaic electricity generated by photovoltaic panel 286 for later use to power, for example, the movement of the flight control surfaces, including rudders 234 (not indicated) and splitter plates 236 (not indicated), the engines 284 of the propulsion system, the valves 247 and 249 (not shown) of respective center ballonets 246 and wingtip ballonets 248 (not shown), as well any cockpit controls, avionics, and environmental and climate controls of gondola 280, and any other functions associated with operation airship 220 that require electrical power.

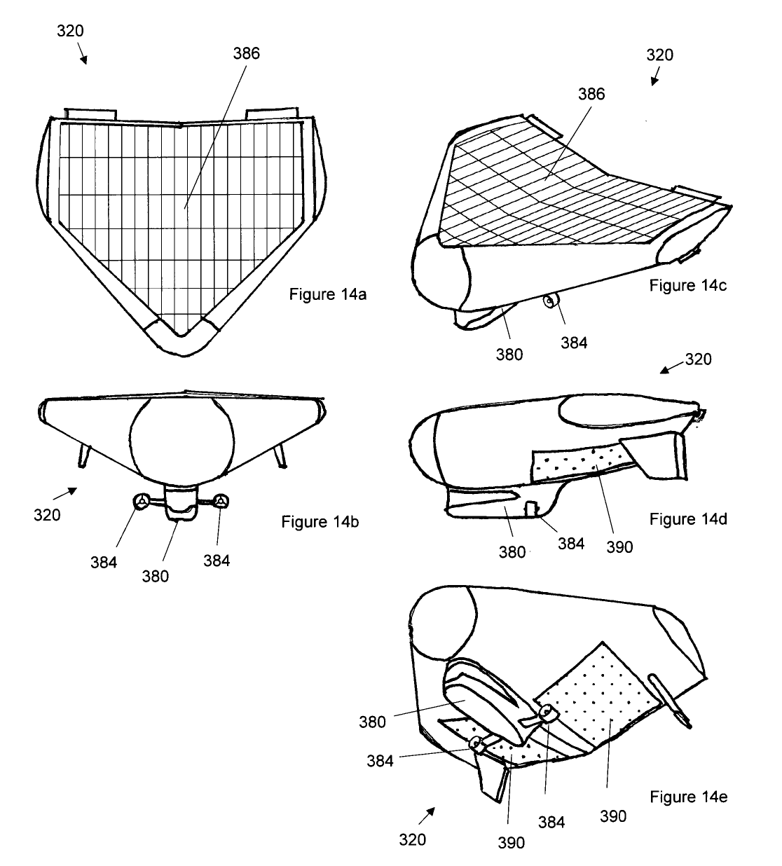

FIGS. 14a to 14e show a variety of views of an embodiment of an airship 320 of the present invention, equipped with a gondola 380, two engines 384, a photovoltaic panel 386, and display panels 390. Each display panel 390 is positioned on an underside of the body of airship 320. In the embodiment shown, each display panel 390 is an electrically powered liquid-crystal display. Each display panel 390 can be used to display, for example, dynamic video images and/or static video images, both of which may be viewed by any person or persons to which airship 320 is visible. For example, display panels 390 may be used for displaying content, such as advertisements, news information, news text, corporate logos, sponsorship information, and the like. Display panels 390 may also be used for the purposes of illumination of the environment surrounding airship 320, such as, for example, to provide illumination of the ground during take-off and landing to assist the piloting of airship 320, or to provide illumination of the exterior of airship 320 for the benefit of persons to which airship 320 is visible.

The combination of both aerodynamic lift and buoyant lift enables the non-rigid airship of the present invention to function as a hybrid airship, and to have operational characteristics of both a fixed-wing aircraft and an airship. For example, the airship is capable of remaining airborne at a low relative air speed, and thereby requires a propulsion system of only modest power. Similarly, the airship is capable of becoming airborne at a low air speed, enabling the airship to take off from a runway of relatively short distance. The airship disclosed herein also combines the fuel efficiency and long endurance that are characteristic of known airships, with the maneuverability and higher speed of fixed-wing aircraft.

The unique operational characteristics of the disclosed non-rigid hybrid airship render it especially well-suited for servicing remote regions. Examples of such remote regions may include any region in which infrastructure for supporting conventional transportation, such as roads for trucking or stations for landing and refueling, may not be available, such as in undeveloped or uninhabited areas, for example. These regions may include arctic regions, jungle regions, and desert regions. Additionally, the special handling and aeronautical properties of the airship of the present invention enable it to both land and take off within a short distance, such as, for example, a soccer field, or any clearing of similar dimensions. The airship of the present invention generally has a longer range (i.e. without refueling) than most heavier-than-air aircraft, including helicopters, and also boasts a modest landing and take-off requirement. Owing to its simple and inflatable construction, the airship disclosed can be readily maintained and/or repaired “in the field” by personnel who are not necessarily highly technically trained or skilled, and in the absence of advanced repair and maintenance facilities.

Importantly, the airship described above is aerodynamically stable in a tethered state, and can therefore be flown in absence of any propulsion. This feature is consistent with the ability of the airship to become and to remain airborne at low relative airspeed, as described above. This enables a number of unique applications for the above described airship, including as a tethered aerostat, such as for the purposes of displaying either information or illuminative light from the display panels, or for airborne measurements, detection, sensing, and the like.

While the above-described embodiments are directed to an airship having two splitter plates, in one embodiment, the airship may have any number of splitter plates greater than two.

While the above-described embodiments are directed to an airship having two fins extending from the body, in one embodiment, any number of fins may extend from the body.

While the above-described embodiments are directed to an airship having fins extending from the underside of the body of the airship, in one embodiment, the fins may extend from the top side of the body. In another embodiment, the fins may extend from both the underside of the body and from the top side.

While the above-described embodiments are directed to an airship having a gondola intended to be manned by persons piloting cockpit controls of the airship, in one embodiment, the airship may be piloted unmanned such as, for example, by remote control.

While the above-described embodiments are directed to an airship having a gondola positioned outside of the body of the airship, in one embodiment, the gondola may be positioned inside the airship.

While the above-described embodiments are directed to an airship that may be flown as a self-propelled aircraft, in one embodiment, the airship may be tethered and flown in a tethered state without self-propulsion. As may be appreciated, this feature is enabled from the inherent stability of the airship at low relative airspeeds.

While the above-described embodiments are directed to an airship comprising gas of lower density than air that is helium, in one embodiment, the gas may be hydrogen, or any other gas that enables buoyancy of the airship in air.

While the above-described embodiments are directed to a hybrid airship having ballonets equipped with independently controllable valves, in one embodiment, the ballonets comprise at least one internal fan for further controlling the flow of air both into and out of the interior of the ballonet and the exterior of the airship.

While the above-described embodiments are directed to an airship having a splitter plate equipped with an actuator that is an electric motor, the actuator may be any actuator known in the art. In one embodiment, the actuator is a pneumatic actuator.

Other methods by which the splitter plates are pivotally connected to the body may be employed. For example, various configurations of load patches and shafts may be employed that fall within the purpose and scope of the invention described.

Although embodiments have been described above with reference to the accompanying drawings, those of skill in the art will appreciate that variations and modifications may be made without departing from the spirit and scope thereof as defined by the appended claims.

What is claimed is:

1. A hybrid airship comprising:
a non-rigid body having a delta-wing shape and an airfoil cross-section, the body shaped for generating aerodynamic lift during forward flight, and containing a gas for generating buoyancy lift; and
at least one splitter plate pivotally connected along a trailing edge of the body, the splitter plate configured to be controllably pivoted for controlling the airship.

2. A hybrid airship according to claim 1, further comprising a control system for controllably pivoting the splitter plate.

3. A hybrid airship according to claim 2, wherein the control system for controllably pivoting the splitter plate comprises an actuator.

4. A hybrid airship according to claim 3, wherein the actuator is an electric motor.

5. A hybrid airship according to claim 1, wherein the splitter plate is connected to an inner shaft, the inner shaft being rotatably housed in an outer shaft mounted to the body.

6. A hybrid airship according to claim 5, further comprising a control system for controllably pivoting the splitter plate and the inner shaft within the outer shaft.

7. A hybrid airship according to claim 6, wherein the control system for controllably pivoting the splitter plate comprises an actuator.

8. A hybrid airship according to claim 7, wherein the actuator is an electric motor.

9. A hybrid airship according to claim 5, wherein the outer shaft is mounted to the body by load patches.

10. A hybrid airship according to claim 1, wherein the trailing edge of the body is rounded.

11. A hybrid airship according to claim 1, further comprising at least one fin extending from the body for providing at least one substantially vertical stabilizer.

12. A hybrid airship according to claim 1, further comprising at least one ballonet within the body configured for being vented to the exterior of the body.

13. A hybrid airship according to claim 1, further comprising a gondola comprising cockpit controls for controlling the pivoting of the splitter plate.

14. A hybrid airship according to claim 1 further comprising a propulsion system.

15. A hybrid airship according to claim 1, further comprising a photovoltaic panel disposed on the body.

16. A hybrid airship according to claim 15, further comprising a power storage system configured to store photovoltaic electricity generated by the photovoltaic panel.

17. A hybrid airship according to claim 1, further comprising at least one display panel disposed on the body.

18. A hybrid airship according to claim 1, wherein the airship is dimensioned to be stably flown in a tethered state.

19. A hybrid airship according to claim 1, wherein the splitter plate comprises a honeycomb construction.

20. A splitter plate for a hybrid airship configured to be pivotally connected along a trailing edge of a body of the hybrid airship, the splitter plate configured to be controllably pivoted for controlling the airship.

21. A splitter plate according to claim 20, further comprising a control system for controllably pivoting the splitter plate.

22. A splitter plate according to claim 21, wherein the control system for controllably pivoting the splitter plate comprises an actuator.

23. A splitter plate according to claim 22, wherein the actuator is an electric motor.

24. A splitter plate according to claim 20, wherein the splitter plate is connected to an inner shaft, the inner shaft being rotatably housed in an outer shaft mounted to the body.

25. A splitter plate according to claim 24, further comprising a control system for controllably pivoting the splitter plate and the inner shaft within the outer shaft.

26. A splitter plate according to claim 25, wherein the control system for controllably pivoting the splitter plate comprises an actuator.

27. A splitter plate according to claim 26, wherein the actuator is an electric motor.

28. A splitter plate according to claim 24, wherein the outer shaft is mounted to the body by load patches.

29. A splitter plate according to claim 20, wherein the trailing edge of the body is rounded.

30. A splitter plate according to claim 20, wherein the splitter plate comprises a honeycomb construction.
